(19) United States
(12) Patent Application Publication
(10) Pub. No.: US 2025/0323466 A1
(43) Pub. Date: Oct. 16, 2025

(54) PIN ASSEMBLY STRUCTURE WITH MULTIPLE PIN SPECIFICATIONS

(71) Applicant: Dongguan Wanlvtong Electronics Co., Ltd., Dongguan (CN)

(72) Inventor: Liangzan LIN, Dongguan (CN)

(21) Appl. No.: 19/248,401

(22) Filed: Jun. 24, 2025

(30) Foreign Application Priority Data
Feb. 14, 2025 (CN) 202520238163.7

(51) Int. Cl. H01R 31/06; H01R 13/40

(52) U.S. Cl. CPC H01R 31/065; H01R 13/40

(57) ABSTRACT

A pin assembly structure includes a frame, a housing and a pin assembly. The frame is mounted in the housing. The pin assembly includes a first pin unit and a second pin unit. The first pin unit and the second pin unit are slidably connected on the frame along a vertical direction. The first pin unit includes a first telescopic component and a first linkage component. The second pin unit includes a second telescopic component, which is fixedly provided with a second pin, and the second pin is a three-pole pin whose three poles respectively corresponding to an earth wire, a live wire and a neutral wire. a side of the first linkage component corresponding to the second pin unit is provided with a recessed structure, so that a pole of the three-pole pin corresponding to the E wire is embedded in the side of the first linkage component.

### CROSS-REFERENCE TO RELATED APPLICATIONS

This application claims the benefit of priority from Chinese Patent Application No. 202520238163.7, filed on Feb. 14, 2025. The content of the aforementioned application, including any intervening amendments thereto, is incorporated herein by reference in its entirety.

### TECHNICAL FIELD

This application relates to adapters, and more particularly to a pin assembly structure with multiple pin specifications.

### BACKGROUND

Outbound travel or business trip has become increasingly popularized in recent years. Owing to different standards of power sockets in various countries, there are various specifications and shapes of electrical plugs, which will cause the domestic electrical appliances to be incompatible with the local power sockets, thereby posing great inconvenience to the travel.

In order to facilitate the international travel, an adapter, which has a pin assembly with multiple pin specifications to be compatible with sockets in different regions and a panel with multiple types of receptacles, has emerged in the market. The pin assembly often includes multiple groups of pin units arranged side by side to adapt to sockets of different standards or specifications in different regions. The side-by-side arrangement of multiple pin units within the housing makes a transverse size of the pin assembly relatively large, which results in an increase in the overall size of the adapter, leading to poor portability.

Therefore, it is urgent to design and develop a structurally-compact pin assembly structure with multiple pin specifications to solve at least one of the aforementioned technical problems.

### SUMMARY

This application provides a compact pin assembly structure with multiple pin specifications to solve at least one technical problem above to solve technical problems above. Technical solutions of this application are described as follows.

A pin assembly structure with multiple pin specifications is provided, comprising:
a frame;
a housing; and
a pin assembly;
wherein the frame is mounted in the housing; the pin assembly is slidably connected with the frame along a vertical direction; and the pin assembly comprises a first pin unit and a second pin unit provided side by side;
the first pin unit comprises a first telescopic component and a first linkage component; the first telescopic component and the first linkage component are provided side by side along the vertical direction, and are slidably connected with the frame; the first telescopic component is provided with a first pin, and the first pin is configured to be connected with an external receptacle; and the first linkage component is provided with a through hole, and the through hole is configured for extension or retraction of the first pin;
the second pin unit comprises a second telescopic component, and the second telescopic component is slidably connected with the frame; and the second telescopic component is fixedly provided with a second pin, and the second pin is a three-pole pin whose three poles respectively corresponding to an earth (E) wire, a live (L) wire and a neutral (N) wire; and
a side of the first linkage component corresponding to the second pin unit is provided with a recessed structure, so that a pole of the three-pole pin corresponding to the E wire is configured to be embedded in the side of the first linkage component corresponding to the second pin unit.

In an embodiment, the recessed structure comprises a sliding groove, and the sliding groove is provided on the first linkage component along the vertical direction; and the pole of the three-pole pin corresponding to the E wire is slidably provided in the sliding groove along the vertical direction.

In an embodiment, an embedded structure is provided between the first telescopic component and the first linkage component, so that when the first pin unit retracts into the frame, the first telescopic component is at least partially embedded in the first linkage component.

In an embodiment, the embedded structure comprises an embedded portion, a push portion, a clamping portion, a base, a side wall, a chamber and a linkage groove;
the embedded portion is provided on the first telescopic component, and is configured to protrude towards the first linkage component; the push portion extends towards both ends of a length direction of the first telescopic component; the first pin is provided on the embedded portion; the clamping portion is provided on a side of the first telescopic component; and the clamping portion and a surface of the push portion facing towards the first linkage component are not located at the same horizontal plane; and
the base is provided on an end of the first linkage component; the side wall is provided on a side edge of the base, and is configured to extend along a direction away from the base; the chamber is provided on an end of the base facing towards the first telescopic component; the chamber is configured for the embedded portion to extend into, and the through hole is provided on a bottom of the chamber; and the linkage groove is provided on the side wall, and is configured for the clamping portion to slide therewithin.

In an embodiment, the frame comprises an upper frame portion and a lower frame portion arranged along the vertical direction; a plurality of guide columns are provided between the upper frame portion and the lower frame portion for support; and the first pin unit and the second pin unit are slidably connected on the plurality of guide columns along the vertical direction.

In an embodiment, at least one third pin unit is provided between the first pin unit and the second pin unit; the at least one third pin unit and the first pin unit are arranged side by side; each of the at least one third pin unit comprises a third telescopic component; the third telescopic component is slidably connected on the frame along the vertical direction, and the third telescopic component is fixedly provided with a third pin configured to be connected with the external receptacle.

In an embodiment, the second telescopic component comprises two mounting portions provided side by side; an avoidance space configured is provided between the two mounting portions for accommodating the at least one third pin unit; the second pin is fixedly connected with each of the two mounting portions; and a connecting portion is provided between the two mounting portions, and is configured to connect the two mounting portions.

In an embodiment, each of the first telescopic component, the second telescopic component and the third telescopic component is provided with a toggle end extending out of the frame.

In an embodiment, the first pin, the second pin and the third pin are different from each other in standard specification.

This application has the following beneficial effects.

This application provides the compact pin assembly structure with multiple pin specifications. In the technical solutions of the present disclosure, the recessed structure is provided between the first pin unit and the second pin unit, so as to decrease a transverse size of the first pin unit and the second pin unit, which decreases a whole size of an adapter and improves the portability of the adapter. The recessed structure is configured to ensure stability of movement of the first pin unit or the second pin unit during their processes of being pushed. The embedded structure is provided between the first telescopic component and the first linkage component of the first pin unit, and is configured to decrease a vertical size of the first telescopic component and the first linkage component after the first pin unit retract into an interior space of the frame, which ensures that a size of the adapter in a height direction will not increase. Through the technical solutions of the present disclosure provided herein, more pins can be provided to facilitate to adapt to mutual plugging of receptacle with different specifications. In addition, the recessed structure is provided between the first pin unit and the second pin unit, so as to decrease a transverse size of the pin assembly, which decreases the whole size of the adapter and improves the portability of the adapter.

### BRIEF DESCRIPTION OF THE DRAWINGS

FIG. 1 is a structural diagram of a pin assembly structure with multiple pin specifications according to an embodiment of the present disclosure.

FIG. 2 is a structural diagram of the pin assembly structure with multiple pin specifications according to an embodiment of the present disclosure.

FIG. 3 is a structural diagram of a first pin unit, a second pin unit and a third pin unit extending from a frame according to an embodiment of the present disclosure.

FIG. 4 is an explosive view of the frame and a pin assembly according to an embodiment of the present disclosure.

FIG. 5 is an explosive view of the pin assembly according to an embodiment of the present disclosure.

FIG. 6 is an explosive view of the first pin unit according to an embodiment of the present disclosure.

FIG. 7 is a structural diagram of an adapter according to an embodiment of the present disclosure.

In Figures: housing 100; frame 200; pin assembly 300; first pin unit 310; upper frame portion 201; lower frame portion 202; guide column 203; first telescopic component 311; toggle end 312; first pin 313a; second pin 313b; third pin 313c; embedded portion 316; push portion 317; clamping portion 318; first linkage component 320; base 321; chamber 322; side wall 323; linkage groove 324; second pin unit 330; sliding groove 325; second telescopic component 331; mounting portion 3311; connecting portion 3312; avoidance space 3313; third pin unit 340; and third telescopic component 341.

### DETAILED DESCRIPTION OF EMBODIMENTS

In order to facilitate the understanding of those skilled in the art, this application will be further described with reference to the embodiments and the accompanying drawings. The embodiments described herein are not intended to limit the disclosure. This application will be completely described with reference to the accompanying drawings.

A pin assembly structure with multiple pin specifications is provided to be used as an important component of an adapter. The pin assembly structure comprises a frame 200. A main jack and an auxiliary jack are provided on the frame 200, and the main jack and the auxiliary jack are provided on adjacent two side surfaces on the frame 200. In this embodiment, the main jack is provided in a plurality of sets arranged side by side along a direction, and the plurality of sets of the main jacks are set with different specifications. In an embodiment, the plurality of sets of the main jacks are set as at least one specification of two-pole jack and at least one specification of three-pole jack. The auxiliary jack is provided on a side surface along the direction extending from where the plurality of sets of the main jacks arranged side by side, so that the adapter can provide more plug positions through the frame, and more electrical appliances can be plugged in when using electrical appliances. A pin assembly 300 configured to connect with an external receptacle is provided on the frame 200, so as to enable the adapter to be energized, which facilitates the use of electricity by electrical devices on the adapter. In order to enable receptacles and pins from different regions or with different specifications to mutually connect, the pin assembly 300 includes a first pin unit 310 and a second pin unit 330 provided side by side. The first pin unit 310 and the second pin unit 330 are slidably connected on the frame. A recessed structure is provided on the first pin unit 310 and the second pin unit 330, so that the pin of the second pin unit 330 can be embedded into the first pin unit 310, which decreases a transverse size of the pin units arranged side by side, thereby reducing a whole size of the adapter and making it more convenient to carry.

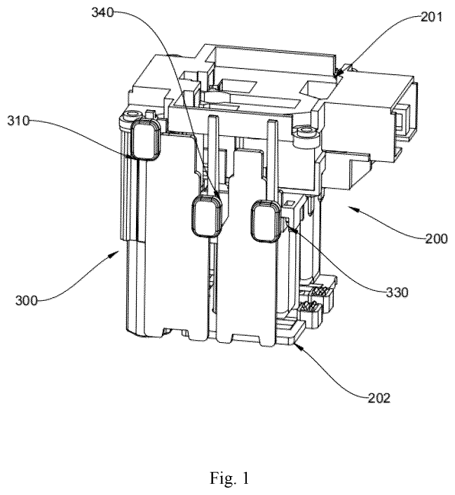

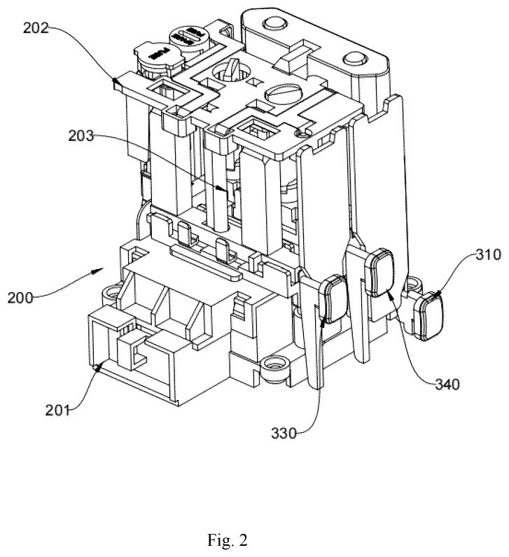

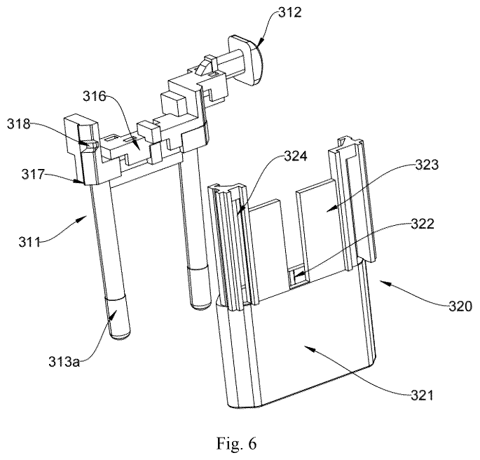

In this embodiment, referring to FIGS. 1-6, the pin assembly structure with multiple pin specifications is provided. The pin assembly structure includes a housing 100, the frame 200 and the pin assembly 300. The frame 200 is mounted in the housing 100. The pin assembly 300 is slidably connected with the frame 200 along a vertical direction. The pin assembly 300 includes the first pin unit 310 and the second pin unit 330 provided side by side, where the first pin unit 310 includes a first telescopic component 311 and a first linkage component 320, the first telescopic component 311 and the first linkage component 320 are provided side by side along the vertical direction, and are slidably connected with the frame 200. The first telescopic component 311 is provided with a first pin 313a, and the first pin 313a is configured to be connected with the external receptacle. The first linkage component 320 is provided with a through hole, and the through hole is configured for extension or retraction of the first pin 313a. The second pin unit 330 includes a second telescopic component 331, and the second telescopic component 331 is slidably connected with the frame 200. The second telescopic component 331 is fixedly provided with a second pin 313b, and the second pin 313b is a three-pole pin whose three poles respectively corresponding to an earth (E) wire, a live (L) wire and a neutral (N) wire. A side of the first linkage component 320 corresponding to the second pin unit 330 is provided with the recessed structure, so that a pole of the three-pole pin corresponding to the E wire is configured to be embedded in the side of the first linkage component 320 corresponding to the second pin unit 330.

In this embodiment, the first pin unit 310 is set as a European standard pin unit, and the second pin unit 330 is set as a British standard pin. After the pole of the three-pole pin corresponding to the E wire is mutually embedded with the first linkage component 320 through the recessed structure, a transverse size of the first pin unit 310 and the second pin unit 330 is decreases, so as to decrease a transverse size of the pin assembly 300, which further makes the adapter have a relatively compact structure. In such way, the whole size of the adapter is decreased, which reduces space occupied by luggage during business trips and improves portability.

In an embodiment, the recessed structure includes a sliding groove 325. The sliding groove 325 is provided on the first linkage component 320 along the vertical direction. The pole of the three-pole pin corresponding to the E wire is slidably provided in the sliding groove 325 along the vertical direction. During use, the pole of the three-pole pin corresponding to the E wire is embedded in the sliding groove 325, so that a transverse size of the second pin unit 330 and the first pin unit 310 is decreased. That is, during mounting, a distance between the second pin unit 330 and the first pin unit 310 can be further decreased to decrease a width size of the adapter. During the first pin unit 310 or the second pin unit 330 extends or retracts, the pole of the three-pole pin corresponding to the E wire slidably cooperates with the sliding groove 325, so as to plays guiding and stabilizing role roles, which makes the first pin unit 310 and the second pin unit 330 more stable during extending.

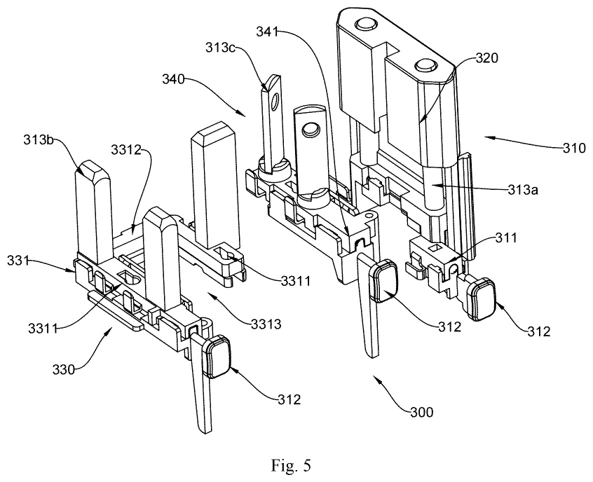

In this embodiment, referring to FIGS. 1 and 5, an embedded structure is provided between the first telescopic component 311 and the first linkage component 320, so that when the first pin unit 310 retracts into the frame 200, the first telescopic component 311 is at least partially embedded in the first linkage component 320.

In this embodiment, when the first telescopic component 311 and the first linkage component 320 retract in the frame 200 through the embedded structure, the first telescopic component 311 is at least partially embedded in the first linkage component 320, so as to decrease a whole height size of the first pin unit 310, which ensures the frame 200 is relatively compact, and further ensures the adapter has a compact structure and small volume.

In an embodiment, the embedded structure includes an embedded portion 316, a push portion 317, a clamping portion 318, a base 321, a chamber 322, a side wall 323 and a linkage groove 324. The embedded portion 316 is provided on the first telescopic component 311, and is configured to protrude towards the linkage component 320. The push portion 317 is configured to extend towards both ends of a length direction of the first telescopic component 311. The first pin 313a is provided on the embedded portion 316. The clamping portion 318 is provided on a side of the first telescopic component 311. The clamping portion 318 and a surface of the push portion 317 facing towards the linkage component 320 are not located at the same horizontal plane. The base 321 is provided on an end of the linkage component 320. The side wall 323 is provided on a side edge of the base 321, and is configured to extend along a direction away from the base 321. The chamber 322 is provided on an end of the base 321 facing towards the first telescopic component 311. The chamber 322 is configured for the embedded portion 316 to extend into, and the through hole is provided on a bottom of the chamber 322. The linkage groove 324 is provided on the side wall 323, and is configured for the clamping portion 318 to slide therewithin.

The first telescopic component 311 is provided with the embedded portion 316 and the push portion 317, such that when the first pin 313a is fixed on the embedded portion 316, the embedded portion 316 has enough space to ensure mounting requirements and mutual insulation between the first pin 313a and the embedded portion 316. When the first pin unit 310 is pushed out, the embedded portion 316 extends into the chamber 322 of the first linkage component 320, and the push portion 317 is in contact with an end of the base 321 of the first linkage component 320, so that the first linkage component 320 is pushed out. When the first pin unit 310 retracts into the interior space of the frame 200, the first telescopic component 311 is pulled, at this time, the clamping portion 318 slides in the linkage groove 324. After being limited by a top of the sliding groove 325, the clamping portion 318 drives the first linkage component 320 to retract into the interior space of the frame 200. Through the above structure, after the first pin unit 310 retracts into the interior space of the frame 200, the overall structure of the adapter becomes compact to avoid an increase in the height of the adapter.

In this embodiment, the frame 200 includes an upper frame portion 201 and a lower frame portion 202 arranged along the vertical direction. A plurality of guide columns 203 are provided between the upper frame portion 201 and the lower frame portion 202 for support. The first pin unit 310 and the second pin unit 330 are connected on the plurality of guide columns 203 along the vertical direction.

In this embodiment, referring to FIGS. 1-4, at least one third pin unit 340 is provided between the first pin unit 310 and the second pin unit 330. The at least one third pin unit 340 and the first pin unit 310 are arranged side by side. Each of the at least one third pin unit 340 includes a third telescopic component 341. The third telescopic component 341 is slidably connected on the frame 200 along the vertical direction, and the third telescopic component 341 is fixedly provided with a third pin 313c configured to be connected with the external receptacle.

In this embodiment, the first pin 313a, the second pin 313b and the third pin 313c are provided to enhance the usability of the adapter and better adapt to external receptacle. In an embodiment, the first pin 313a, the second pin 313b and the third pin 313c respectively provided on the first pin unit 310, the second pin unit 330 and the third pin unit 340 have different standard specifications. In an embodiment, each of the first pin 313a, the second pin 313b and the third pin 313c is a pin with a specification selected from European standard, Japanese standard, British standard, Indian standard, Australian standard and Chinese standard.

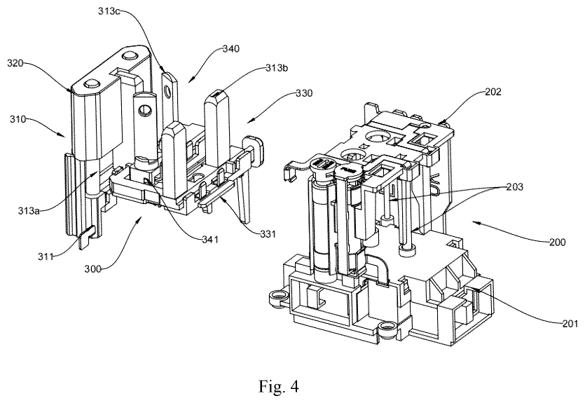

In this embodiment, in order to facilitate the movement of the third pin unit 340, referring to FIG. 4, the second telescopic component 331 of the second pin unit 330 has the following design. The second telescopic component 331 includes two mounting portions 3311 provided side by side. An avoidance space 3313 is provided between the two mounting portions 3311 for accommodating the at least one third pin unit 340. Each of the two mounting portions 3311 is fixedly provided with the second pin 313b. A connecting portion 3312 is provided between the two mounting portions 3311, and is configured to connect the two mounting portions 3311.

That is, the pole of the three-pole pin corresponding to the E wire of the second pin unit 330 is arranged on one of the two mounting portions 3311 corresponding to the first pin unit 310. The third pin 313c and the second pin 313b are arranged on the other of the two mounting portions 3311 away from the first pin unit 310. The two mounting portions 3311 are connected with each other through the connecting portion 3312 to form a whole structure, so that the avoidance space 3313 configured for the at least one third pin unit 340 is provided between the two mounting portions 3311. In such arrangement, the at least one third pin unit 340 is arranged in the second pin unit 330, which further improves the compactness of the pin assembly 300 and decreases the whole size of the pin assembly 300.

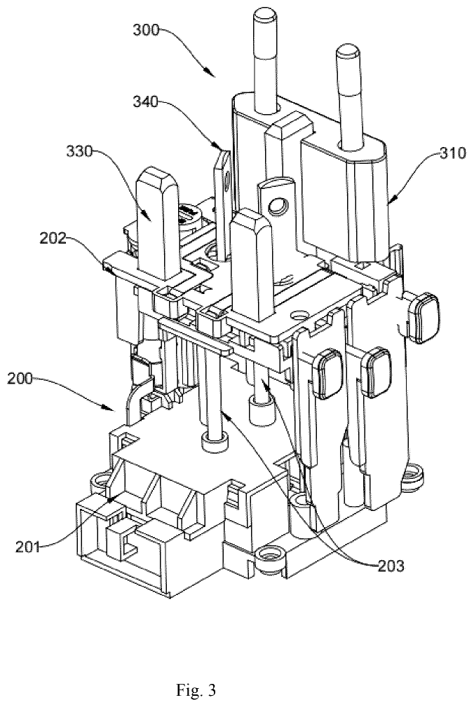

In this embodiment, referring to FIGS. 3-4, in order to facilitate the first pin unit, the second pin unit and the at least one third pin unit to extend or retract on the frame 200, each of the first telescopic component 311, the second telescopic component 331 and the third telescopic component 341 is provided with a toggle end 312 extending out of the frame 200.

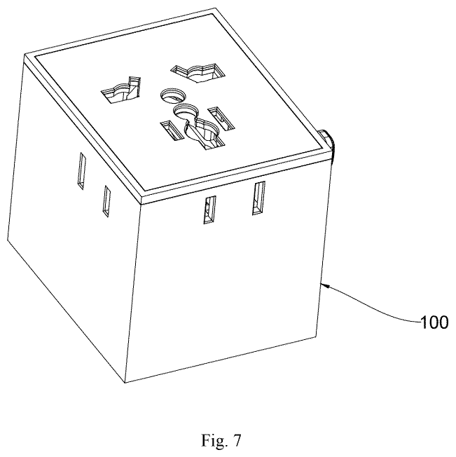

Referring to FIG. 7, in order to apply the adapter with the frame of the present disclosure, two receptacle panels are provided on the housing 100. The two receptacle panels are configured as a main receptacle panel and an auxiliary receptacle panel adjacent to each other, so as to provide more positions for two electrical appliances to be simultaneously plugged therein.

Described above are merely preferred embodiments of the present disclosure, which are not intended to limit the disclosure. It should be noted that various improvements, equivalent replacements and modifications made by those of ordinary skill in the art without departing the spirit of the present disclosure, shall fall within the scope of this application defined by the appended claims.

What is claimed is:

1. A pin assembly structure, comprising:
a frame;
a housing; and
a pin assembly;
wherein the frame is mounted in the housing; the pin assembly is slidably connected with the frame along a vertical direction; and the pin assembly comprises a first pin unit and a second pin unit provided side by side;
the first pin unit comprises a first telescopic component and a first linkage component; the first telescopic component and the first linkage component are provided side by side along the vertical direction, and are slidably connected with the frame; the first telescopic component is provided with a first pin, and the first pin is configured to be connected with an external receptacle; and the first linkage component is provided with a through hole, and the through hole is configured for extension or retraction of the first pin;
the second pin unit comprises a second telescopic component, and the second telescopic component is slidably connected with the frame; and the second telescopic component is fixedly provided with a second pin, and the second pin is a three-pole pin whose three poles respectively corresponding to an earth (E) wire, a live (L) wire and a neutral (N) wire; and
a side of the first linkage component corresponding to the second pin unit is provided with a recessed structure, so that a pole of the three-pole pin corresponding to the E wire is embedded in the side of the first linkage component corresponding to the second pin unit.

2. The pin assembly structure of claim 1, wherein the recessed structure comprises a sliding groove provided on the first linkage component along the vertical direction; and the pole of the three-pole pin corresponding to the E wire is slidably provided in the sliding groove along the vertical direction.

3. The pin assembly structure of claim 2, wherein an embedded structure is provided between the first telescopic component and the first linkage component, so that in response to a case that the first pin unit retracts into the frame, the first telescopic component is at least partially embedded in the first linkage component.

4. The pin assembly structure of claim 3, wherein the embedded structure comprises an embedded portion, a push portion, a clamping portion, a base, a side wall, a chamber and a groove;
the embedded portion is provided on the first telescopic component, and is configured to protrude towards the first linkage component; the push portion is configured to extend towards both ends of a length direction of the first telescopic component; the first pin is provided on the embedded portion; the clamping portion is provided on a side of the first telescopic component; and the clamping portion and a surface of the push portion facing towards the first linkage component are not located at the same horizontal plane; and
the base is provided on an end of the first linkage component; the side wall is provided on a side edge of the base, and is configured to extend along a direction away from the base; the chamber is provided on an end of the base facing towards the first telescopic component; the chamber is configured for the embedded portion to extend into, and the through hole is provided on a bottom of the chamber; and the groove is provided on the side wall, and is configured for the clamping portion to slide therewithin.

5. The pin assembly structure of claim 1, wherein the frame comprises an upper frame portion and a lower frame portion arranged along the vertical direction; a plurality of guide columns are provided between the upper frame portion and the lower frame portion for support; and the first pin unit and the second pin unit are slidably connected on the plurality of guide columns along the vertical direction.

6. The pin assembly structure of claim 1, wherein at least one third pin unit is provided between the first pin unit and the second pin unit; the at least one third pin unit and the first pin unit are arranged side by side; each of the at least one third pin unit comprises a third telescopic component; the third telescopic component is slidably connected on the frame along the vertical direction, and the third telescopic component is fixedly provided with a third pin configured to be connected with the external receptacle.

7. The pin assembly structure of claim 6, wherein the second telescopic component comprises two mounting portions provided side by side; an avoidance space is provided between the two mounting portions for accommodating the at least one third pin unit; the second pin is fixedly connected with each of the two mounting portions; and a connecting portion is provided between the two mounting portions to connect the two mounting portions.

8. The pin assembly structure of claim 6, wherein each of the first telescopic component, the second telescopic component and the third telescopic component is provided with a toggle end extending out of the frame.

9. The pin assembly structure of claim 6, wherein the first pin, the second pin and the third pin are different from each other in standard specification.
